(19) United States
(12) Patent Application Publication
(10) Pub. No.: US 2022/0111494 A1
(43) Pub. Date: Apr. 14, 2022

(54) COMBINATION SWIVEL WRENCH

(71) Applicant: Evsevy Reutov, Homer, AK (US)

(72) Inventor: Evsevy Reutov, Homer, AK (US)

(21) Appl. No.: 17/066,737

(22) Filed: Oct. 9, 2020

(51) Int. Cl. B25B 13/48; B25B 23/00; B25B 13/46

(52) U.S. Cl. CPC B25B 13/481; B25B 13/46; B25B 23/0028

(57) ABSTRACT

Illustrated views of an exemplary combination swivel wrench for easy access to tight spaces is presented. The combination swivel wrench is useful for accessing hex fasteners in hard to get to areas such as tight areas. Further, the combination swivel wrench is useful for providing both a swivel and a ratchet on a common combination wrench.

### FIELD OF THE INVENTION

This invention relates to hand tools. More particularly, it relates to a combination wrench that swivels.

### BACKGROUND

A wrench or spanner is a tool used to provide grip and mechanical advantage in applying torque to turn objects—usually rotary fasteners, such as nuts and fasteners—or keep them from turning. The term wrench is generally used for tools that turn non-fastening devices (e.g. tap wrench and pipe wrench) or may be used for a monkey wrench—an adjustable pipe wrench.

Higher quality wrenches are typically made from chromium-vanadium alloy tool steels and are often drop-forged. They are frequently chrome-plated to resist corrosion and for ease of cleaning.

Hinged tools, such as pliers or tongs, are not generally considered wrenches, but exceptions may include the plumber wrench and Mole wrench.

The combination wrench is a double-ended tool with one end being like an open-end wrench or open-ended spanner, and the other end being like a box-end wrench or ring spanner. Both ends generally fit the same size of hex fastener.

One of the problems with all wrenches currently made is that when trying to use the wrench in a tight area, the wrench does not fit in the area and thus is ineffective.

Accordingly, and in light of the foregoing, there is a need for a device that can loosen screws and nuts in tight areas, preferably by swiveling to allow access to screw/nut and is able to effectively remove the screw/nut in tight areas.

### BRIEF DESCRIPTION OF THE DRAWINGS

FIG. 1A is an illustrated view of an exemplary combination swivel wrench.

FIG. 1B is an illustrated top view of the combination swivel wrench shown in FIG. 1A.

FIG. 2A is an illustrated top view of a second embodiment of a combination swivel wrench.

FIG. 2B is an illustrated left-side view of the second embodiment of the combination swivel wrench shown in FIG. 3A.

FIG. 2C is an illustrated right-side view of the second embodiment of the combination swivel wrench shown in FIG. 3A.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

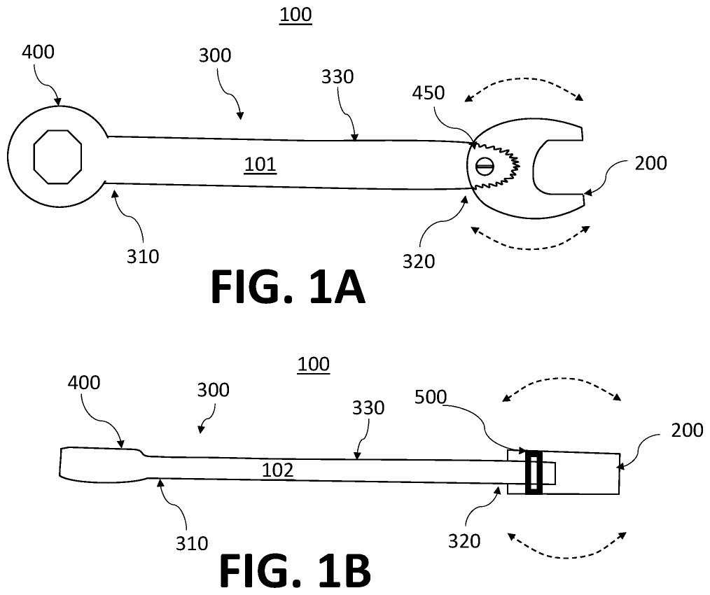

Referring to FIG. 1A and FIG. 1B, illustrated views of an exemplary combination swivel wrench 100 for easy access to tight spaces is presented. The combination swivel wrench 100 is useful for accessing hex fasteners in hard to get to areas such as tight areas. Further, the combination swivel wrench 100 is useful for providing both a swivel and a ratchet on a common combination wrench.

The combination swivel wrench 100 has an open-ended head 200, a beam 300 and a box end 400. The open-ended head 200 and the box end 400 are calibrated to be for the same size hex fastener, such as 7/16, ½, ¾, etc., however the open-ended head 200 and the box end 400 may be different hex fastener sizes.

The beam 300 has a first end 310, a second end 320 and a hand portion 330. The first end 310 is securely coupled to the box end 400 of the combination swivel wrench 100. The second end 320 is movably coupled to the open-ended head 200 of the combination swivel.

The open-ended head 200 of the combination swivel wrench 100 has a swivel 400 and a ratchet 500.

As shown in FIG. 1A, the swivel 400 couples the open-ended head 200 on a first side 101 of the combination swivel wrench 100. The swivel 400 allows for the open-ended head 200 to be moved in a sideways manner in a plurality of directions. The swivel 400 preferably allows a side to side movement of the open-ended head 200 of the combination swivel wrench 100 between zero to ninety degrees (0°-90°) such that the open-ended head 200 can be maneuvered to reach into tight and/or difficult locations of the hex fasteners, although the swivel 400 may have any range as determined to be relevant for those of skill in the art.

The ratchet 500, as shown in FIG. 1B, is coupled to the open-ended head 200 on a second side 102 of the combination swivel wrench 100. The ratchet 500 allows for the open-ended head 200 to be moved in a up and down manner in a plurality of directions. The ratchet 500 preferably allows the up and down movement of the open-ended head 200 of the combination swivel wrench 100 between zero to one hundred eighty degrees (0°-180°) such that the open-ended head 200 can be maneuvered to reach into tight and/or difficult locations of the hex fasteners, although the ratchet 500 may have any range as determined to be relevant for those of skill in the art.

The ratchet 500 allows the nut to be tightened or loosened with a reciprocating motion, without requiring that the wrench be removed and refitted after each turn. Typically, a small lever on the ratchet open-ended head switches the wrench between tightening and loosening mode.

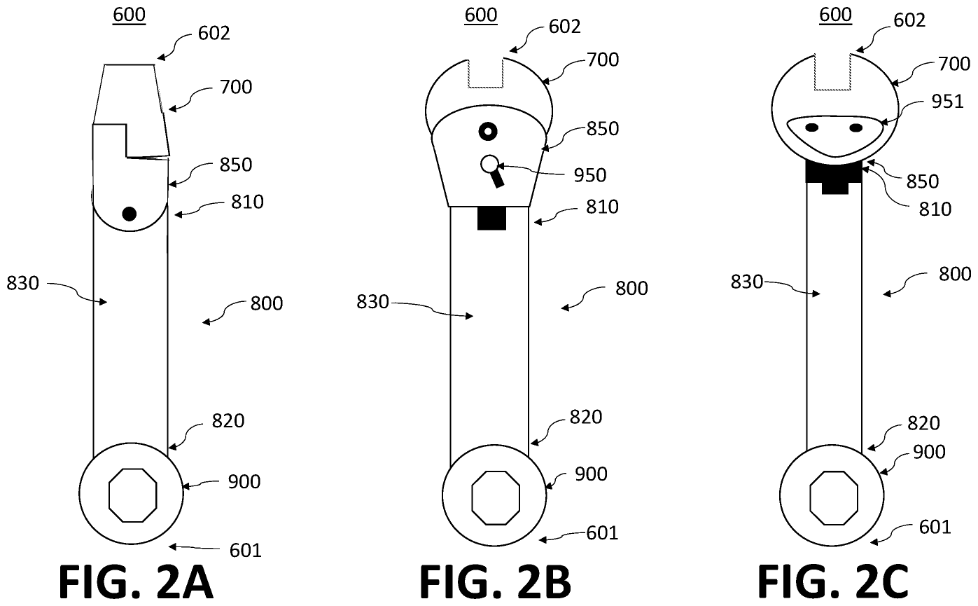

Referring to FIG. 2A, FIG. 2B and FIG. 2C, illustrated views of a second embodiment of an exemplary combination swivel wrench 600 for easy access to tight spaces is presented. The combination swivel wrench 600 is useful for accessing hex fasteners in hard to get to areas such as tight areas. Further, the combination swivel wrench 600 is useful for providing both a swivel and a ratchet on a common combination wrench.

The combination swivel wrench 600 has an open-ended head 700, a beam 800 and a box end 900. The open-ended head 700 and the box end 900 are calibrated to be for the same size hex fastener, such as 7/16, ½, ¾, etc., however the open-ended head 700 and the box end 900 may be different hex fastener sizes.

The beam 800 has a first end 810, a second end 820 and a hand portion 830. The first end 810 is securely coupled to the open-ended head 700 of the combination swivel wrench 600. The second end 820 of the beam 800 is movably coupled to the box end 900 of the combination swivel.

The open-ended head 700 of the combination swivel wrench 600 has a swivel 850 and a locking mechanism 950.

As shown in FIG. 2B, the swivel 850 couples the open-ended head 700 on a first side 601 of the combination swivel wrench 600. The swivel 850 allows for the open-ended head 700 to be moved in a sideways manner in a plurality of directions. The swivel 850 preferably allows a side to side movement of the open-ended head 700 of the combination swivel wrench 600 between zero to ninety degrees (0°-90°) such that the open-ended head 700 can be maneuvered to reach into tight and/or difficult locations of the hex fasteners, although the swivel 850 may have any range as determined to be relevant for those of skill in the art.

The locking mechanism 950, as shown in FIG. 2B, is coupled to the open-ended head 700 on a second side 602 of the combination swivel wrench 600 by a coupling device 951, shown in FIG. 2C. The locking mechanism 950 allows for the open-ended head 700 to be moved in a up and down manner in a plurality of directions. The swivel 850 preferably allows the up and down movement of the open-ended head 700 of the combination swivel wrench 600 between zero to one hundred eighty degrees (0°-180°) such that the open-ended head 700 can be maneuvered to reach into tight and/or difficult locations of the hex fasteners, although the swivel 850 may have any range as determined to be relevant for those of skill in the art. The locking mechanism 950 allows for the open-ended head 700 to be locked into a desired position determinant on the positioning of the swivel 850.

The ratcheting mechanism allows the nut to be tightened or loosened with a reciprocating motion, without requiring that the wrench be removed and refitted after each turn. Typically, a small lever on the ratchet open-ended head switches the wrench between tightening and loosening mode.

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A combination swivel wrench for reaching hex fasteners in hard to get to and tight spaces, the combination swivel wrench consisting of:
a beam, the beam having a first end, a second end and a hand portion;
an open end, the open end being movably coupled to a second end of the beam, wherein the open end being for tightening and loosening hex fasteners;
a box end, the box end being securely coupled to a first end of the beam, wherein the box end being for tightening and loosening hex fasteners;
a swivel, the swivel configured to couple the open end to the second end of a first side of the beam, wherein the up and down direction being a range of between 0° and 180°; and
a ratchet, the ratchet configured to couple the open end to the second end of a second side of the beam.

2. The combination swivel wrench, wherein the swivel being configured to move the open end in a side-to-side direction.

3. The combination swivel wrench, wherein the side-to-side direction being a range of between 0° and 90°.

4. The combination swivel wrench, wherein the ratchet being configured to move the open end in an up and down direction.

5. (canceled)
